(19) United States
(12) Patent Application Publication
(10) Pub. No.: US 2006/0251941 A1
(43) Pub. Date: Nov. 9, 2006

(54) Method for treating a fuel cell membrane, a fuel cell, and a conditioned fuel cell membrane

(75) Inventors: Michael Davis, Spokane, WA (US); William A. Fuglevand, Spokane, WA (US); David R. Lott, Spokane, WA (US)

Correspondence Address: WELLS ST. JOHN P.S., 601 W. FIRST AVENUE, SUITE 1300, SPOKANE, WA, 99201, US

(73) Assignee: ReliOn, Inc.

(21) Appl. No.: 11/123,379

(22) Filed: May 5, 2005

(51) Int. Cl. H01M 8/10; C08J 5/22

(52) U.S. Cl. 429/30; 429/49; 521/26

(57) ABSTRACT

A method for treating a fuel cell membrane is described and which includes providing a fuel cell membrane which is not generating an electrical current output; and exposing the fuel cell membrane which is not generating an electrical current output to a nonambient environment which is effective to render the fuel cell membrane substantially immediately operable to generate at least about 80% of the maximum sustainable electrical power output of the fuel cell membrane when it is supplied with a source of fuel and an oxidant. The present invention also describes a fuel cell produced by the same methodology and a conditioned fuel cell membrane.

### TECHNICAL FIELD

The present invention relates to a method for treating a fuel cell membrane, a fuel cell produced by the disclosed methodology and a conditioned fuel cell membrane, and more specifically to methodology which is effective to render the fuel cell membrane substantially immediately operable to generate at least 80% of the maximum sustainable electrical power output of the fuel cell membrane when it is supplied with a source of a fuel and an oxidant.

### BACKGROUND OF THE INVENTION

A fuel cell is a device which can readily convert chemical energy to electrical energy by the reaction of a fuel gas with a suitable oxidant supply. In a proton exchange membrane fuel cell, for example, the fuel gas is typically hydrogen and the oxidant supply comprises oxygen (or more typically ambient air). In fuel cells of this type, a membrane electrode diffusion layer assembly is provided, and which includes a solid polymer electrolyte with opposite anode and cathode sides. Appropriate electrodes are provided on the opposite anode and cathode sides. During operation, a fuel gas reacts with a catalyst which is present in the electrode on the anode side to produce hydrogen ions which migrate through the solid polymer electrolyte to the opposite cathode side. Meanwhile, an oxidant supply introduced or provided to the cathode side is present to react with the hydrogen ions in the presence of the catalyst which is incorporated into the electrode on that side, to produce water and a resulting electrical output.

In proton exchange membrane fuel cells which use a Nafion® based membrane, an initial “conditioning” process must be undertaken prior to the fuel cell being rendered operable to produce full power output. The primary function of this “conditioning” process or phase is to prepare the membrane-electrode assembly to produce full rated power. That is, the maximum sustainable amount of electrical power which is possible. A key part of this process is to introduce a proper amount of water into the proton exchange membrane and which facilitates effective proton conductivity. As noted above, one of the by-products produced by the operation of a proton exchange membrane fuel cell is water. As a general matter, most previously employed conditioning processes use the water created by the fuel cell itself, at least in part, for the conditioning of the fuel cell membrane. In this regard, for newly fabricated proton exchange membranes, typically a fuel cell which is utilizing same is first operated at a very low current output level as water is initially produced by the fuel cell. Then, as more water is created by the fuel cell, during operation, the corresponding conductivity of the fuel cell membrane continues to increase. As the fuel cell membrane's ionic conductivity increases, more electrical power is generated by the fuel cell. In this cycle, as more electrical current is generated, more water is produced by the fuel cell. This conditioning cycle continues until the fuel cell membrane is fully hydrated and the maximum sustainable power output is achieved by same.

While this “conditioning” process has operated with a degree of success, it has shortcomings which have detracted from its usefulness. Chief among its shortcomings is that this conditioning process takes a considerable amount of time to achieve. Fuel cell membrane conditioning may take as long as 8 hours under typical ambient environmental conditions. Consequently, the time delay associated with this conditioning process provides a substantial impediment to the efficient manufacturing of fuel cells. Researchers, trying to address this issue, have tried various schemes to reduce the conditioning time for these fuel cell membranes. For example, one approach attempted, heretofore, has been to provide a humidified fuel gas stream to the fuel cell membrane during the conditioning process. However, these previous attempts have not appeared to have been successful inasmuch as the available research appears to indicate that conditioning times do not appear to be substantially decreased by using a humidified fuel gas supply as opposed to a substantially dry hydrogen fuel supply.

A method for treating a fuel cell membrane which addresses the perceived shortcomings in the prior art practices which have been utilized heretofore is the subject matter of the present invention.

### SUMMARY OF THE INVENTION

Therefore, a first aspect of the present invention relates to a method for treating a fuel cell membrane which includes providing a fuel cell membrane which is not generating an electrical current output; and exposing the fuel cell membrane which is not generating an electrical current output to a nonambient environment which is effective to render the fuel cell membrane substantially immediately operable to generate at least about 80% of the maximum sustainable electrical power output of the fuel cell membrane when it is supplied with a source of fuel and an oxidant.

Another aspect of the present invention relates to a method of treating a fuel cell membrane which includes providing a nominally operable fuel cell membrane, and which is not currently producing an electrical power output; providing an enclosure defining a cavity; placing the nominally operable fuel cell membrane in the cavity of the enclosure; increasing the pressure, temperature and humidity experienced by the nominally operable fuel cell membrane within the cavity to create a nonambient environment; retaining the nominally operable fuel cell membrane in the cavity for a time period which is effective to render the fuel cell membrane conditioned and substantially immediately operable to generate at least about 80% of the maximum sustainable electrical power output of the fuel cell membrane when it is subsequently supplied with a source of a fuel gas and an oxidant; and removing the conditioned fuel cell membrane from the enclosure.

Still further, another aspect of the present invention relates to a fuel cell including a fuel cell module, and a fuel cell stack produced by the methodology of the present invention.

Still another aspect of the present invention relates to a method for treating a fuel cell membrane which includes providing a nominally operable fuel cell membrane which, if provided with a source of fuel and an oxidant, would immediately supply an electrical power output of less than about 80% of its optimal electrical power output; selecting a time period for the treatment of the nominally operable fuel cell membrane; providing an enclosure defining a cavity; placing the nominally operable fuel cell membrane within the cavity of the enclosure; selecting and supplying a nonambient and substantially nondamaging temperature, pressure and humidity which is experienced by the nominally operable fuel cell membrane within the cavity, and which is effective to render the nominally operable fuel cell membrane conditioned, and immediately operable to produce at least about 80% of the conditioned fuel cell membranes' optimal sustainable electrical output when the conditioned fuel cell membrane is removed from the cavity of the enclosure and is supplied with a source of a fuel and an oxidant; removing the conditioned fuel cell membrane from the enclosure; and rendering the conditioned fuel cell membrane operable to produce an electrical power output which is greater than about 80% of the optimal sustainable electrical current output of the conditioned fuel cell membrane.

Yet a further aspect of the present invention relates to a conditioned fuel cell membrane which includes a nominally operable fuel cell membrane which, prior to conditioning, cannot immediately deliver an optimal electrical power output when supplied with a fuel gas and an oxidant, and which, following conditioning, and when subsequently rendered operational by a fuel cell, is operable to supply an optimal electrical power output within less than about one hour of operation of the fuel cell.

These and other aspects of the present invention will be discussed in greater detail hereinafter.

### BRIEF DESCRIPTION OF THE DRAWINGS

Preferred embodiments of the invention are described below with reference to the following accompanying drawings.

FIG. 1 is a greatly enlarged, fragmentary, vertical sectional view of a membrane electrode diffusion layer assembly and which illustrates a portion of the methodology of the present invention.

FIG. 2 is a prior art fuel cell module as more fully described in U.S. Pat. No. 6,030,718 and which incorporates the membrane electrode diffusion layer assembly as illustrated in FIG. 1.

FIG. 3 is a prior art fuel cell stack as more fully described in U.S. Pat. No. 6,703,155 and which further incorporates the membrane electrode diffusion layer assembly as illustrated in FIG. 1.

FIG. 4 is a prior art fuel cell module as more fully described in U.S. Pat. No. 6,468,682; and which incorporates the membrane electrode diffusion layer assembly as illustrated in FIG. 1.

FIG. 5 is a greatly simplified, graphic depiction, of an arrangement for practicing the methodology of the present invention.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

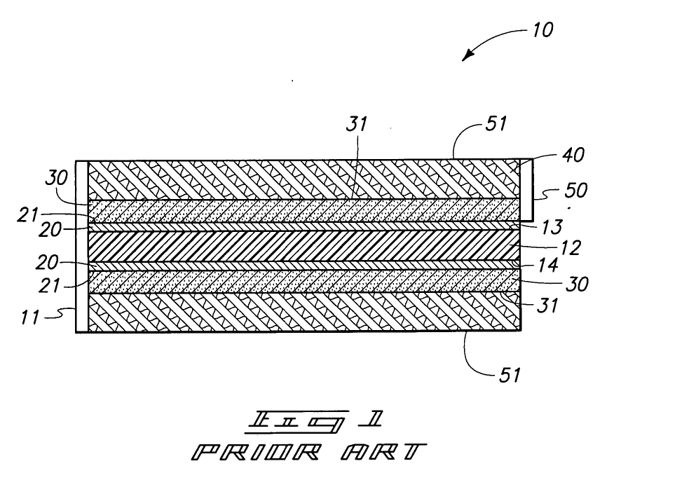

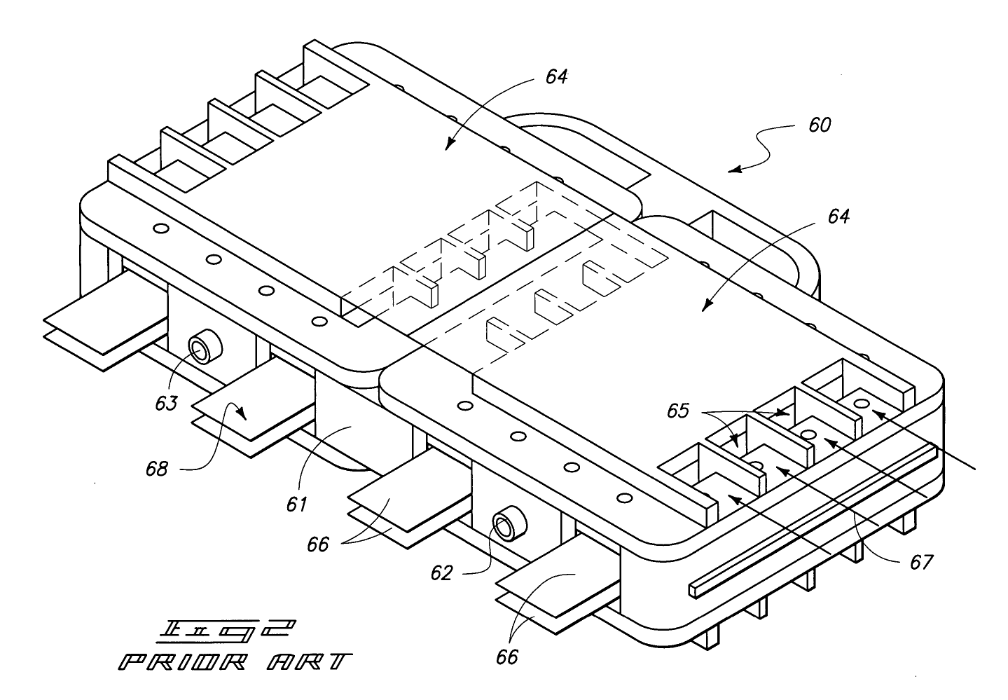

The present invention is best understood by a study of FIGS. 1-5, respectively. Referring now to FIG. 1, the methodology of the present invention is generally indicated by the numeral 10 and begins with a first step of providing an ion exchange fuel cell membrane which is not generating an electrical current output and which is generally indicated by the numeral 11. This assembly 11, is often referred to as a membrane electrode diffusion assembly (MEDA) and is received within or made integral with a fuel cell module, device or stack such as seen in FIGS. 2, 3 and 4, respectively, and which will be discussed in greater detail hereinafter. For purposes of the present discussion, however, the fuel cell membrane or MEDA as will be disclosed below is useful in fuel cell devices which operate at temperatures of less than about 300° C. Consequently, these assemblies are not useful in solid oxide fuel cell designs or other fuel cells which generally operate at temperatures greater than about 300° C. As will be appreciated by a study of FIG. 1, the MEDA 11 will typically utilize an ion exchange membrane 12 such as may be purchased under the trade name (Nafion). This ion exchange membrane is a thin, flexible and sheet-like material which is made from a fluoropolymer. This ion exchange membrane is commercially available from the DuPont™ Company. The ion exchange membrane 12 has opposite anode and cathode sides 13 and 14 respectively.

As will be further seen in FIG. 1, an electrode layer 20 is disposed in juxtaposed ionic exchanging relation relative to the respective anode and cathode sides 13 and 14, respectively. The electrode layer 20 is of conventional design, and which, during fuel cell operation, facilitates the creation and movement of ions across the ion exchange membrane 12. Each electrode layer 12 has an outwardly facing surface 21. As seen in FIG. 1, a micro-diffusion layer or first portion 30 having a given degree of porosity is juxtaposed relative to the outwardly facing surface 21 of the electrode layer 20. The micro-diffusion layer 30 comprises a carbon based material which may be modified, as needed from time to time, to provide different levels porosity for the anode side 13 and the cathode side 14, respectively.

Still further, the porosity of the micro-diffusion layer 30 may be manipulated in various ways to achieve various desired performance characteristics, and parameters such as effective hydration of a fuel cell as will be described hereinafter. Yet further, while the micro-diffusion layer 30 is shown as a single layer, the micro-diffusion layer may comprise individually discreet layers each having a different porosity. Moreover, while the porosity of the micro-diffusion layer 30 may vary in its porosity across its thickness dimension, it is also possible that the micro-diffusion layer may vary in it's porosity in the X and/or Y axes, that is, along the same plane as the outwardly facing surface area 31.

Still referring to FIG. 1, it will be seen that a macro-diffusion layer or second portion, is generally indicated by the numeral 40, and is immediately juxtaposed relative to the outwardly facing surface area 31 of the micro-diffusion layer 30. The macro-diffusion layer comprises, in one form, a carbon fiber based sheet having a porosity which is, as a general matter, greater than the porosity of the micro-diffusion layer 30. This macro-diffusion layer can be commercially purchased from various commercial sources including Toray Composites America. The micro-diffusion layer 30 and the macro-diffusion layer 40, in combination, define a gas diffusion layer (GDL) which is generally indicated by the numeral 50. The gas diffusion layer 50 has an outwardly facing surface area 51 which has a surface texture or topology. It should be understood that the gas diffusion layer, while described herein, as including both macro-diffusion layer 40, and micro-diffusion layer 30, may, in some forms of the invention, include only one of these two previously described diffusion layers. It being understood that FIG. 1 shows a preferred form of a MEDA. The porosity of the macro-diffusion layer 40 may be varied utilizing various prior art practices. Similarly, as discussed with respect to the micro-diffusion layer, the porosity of the macro-diffusion layer may be varied in the X, Y and Z axes. It will be understood that in some forms of the MEDA, a porous metal coating (not shown) which comprises one or more elements selected from the periodic table of elements and which has an atomic number of 13-75 may be positioned in at least partial covering relation relative to the outwardly facing surface area 51 of the gas diffusion layer 50. This metal coating or material forms a resulting metalized gas diffusion layer which is gas porous. A structure such as this is described more fully in U.S. Pat. No. 6,716,549, the teachings of which are incorporated by reference herein.

In its broadest aspect, the method 10 for treating a fuel cell membrane 11 includes the steps of providing a fuel cell membrane 11 which is not generating electrical current output; and exposing the fuel cell membrane which is not generating an electrical current output to a nonambient environment for a time period which is effective to render the fuel cell membrane 11 substantially immediately operable to generate at least about 80% of the maximum sustainable electrical power output of the fuel cell membrane when it is supplied with a source of fuel and an oxidant. The conditions that the fuel cell membrane are exposed to are those which would not significantly impair the operability of the resulting conditioned fuel cell membrane 11 when the conditioned fuel cell membrane is later removed from the environment and is subsequently rendered operational to generate electricity.

A fuel cell membrane (MEDA) 11 such as shown in FIG. 1 may be incorporated into a number of fuel cells as illustrated in FIGS. 2, 3 and 4, respectively, and which are indicated as prior art.

Referring now to FIG. 2, a prior art ion exchange fuel cell module 60 and which is more fully described in U.S. Pat. No. 6,030,718 is shown. The teachings of this patent are incorporated by reference herein. As seen in FIG. 2, the ion exchange membrane fuel cell module 60 which incorporates the MEDA 11 as seen in FIG. 1 has a main body 61 and which defines a fuel intake or delivery port 62. The fuel intake or delivery port supplies a source of a fuel gas (not shown) to the anode sides 13 of the respective membrane electrode diffusion layer assemblies 11 which are described with respect to FIG. 1. Still further, the main body 61 defines a by-product exhaust port 63 which removes waste water, unreacted fuel gas and any resulting by-products from the anode and cathode sides 13 and 14 of the membrane electrode diffusion layer assemblies 11 which are enclosed therein. As should be understood, the fuel intake port 62 is coupled in releasable fluid flowing relation relative to a fuel gas outlet, not shown, and which is made integral with a fuel cell housing (not shown). In addition, the fuel cell module 60 includes cathode covers 64 which cooperate with the main body 51 and which exert force on adjacent current collectors which are described below. The cathode covers 64 define cathode air passageways 65 which allow a stream of air (oxygen) provided by an air movement assembly for example, not shown, to move therethrough and move into contact with the cathode sides 14 of the respective membrane electrode diffusion layer assemblies 11 which are enclosed therein. The cathode covers 64 also exert force on adjacent current collectors 66 which are placed or otherwise oriented in ohmic electrical contact relative to the individual membrane electrode diffusion layer assemblies 11 which are enclosed therein. The respective current collectors have electrical tab portions which extend outwardly therefrom and which may be selectively electrically coupled with an electrical bus which is made integral with a fuel cell housing as more fully described in U.S. Pat. No. 6,030,718.

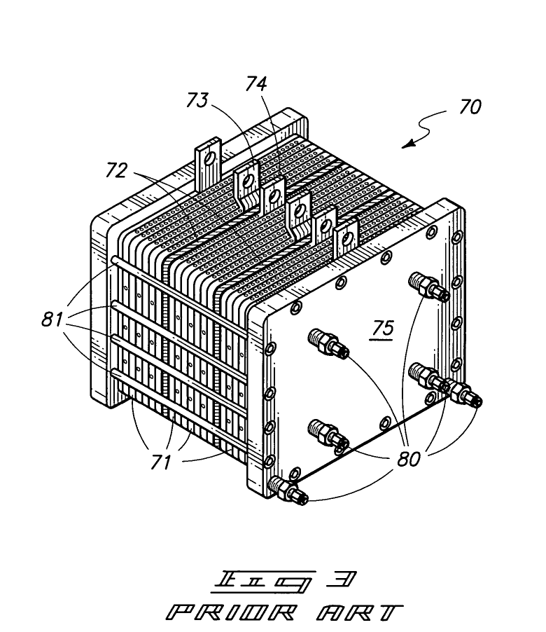

Referring now to FIG. 3, an air-cooled fuel cell stack 70 is shown. The fuel cell stack 70 includes a plurality of substantially aligned proton exchange membranes 71 and insulator plates 72 which are positioned therebetween. The fuel cell stack 70 includes positive polarity current collectors 73; and negative polarity current collectors 74. The fuel cell stack 70 further has a opposed end plates 75 which place the respective proton exchange membranes into compression. At least one of the end plates 75 has a number of fluid couplers 80 made integral therewith. The respective fluid couplers facilitate the delivery of a source of a fuel gas to the various proton exchange membranes or groups of membranes, 71 which are positioned therebetween the end plates 75, and further allows for the removal of by-products, such as water, and any other resulting contaminants from the fuel cell stack 70. The respective end plates 75 cooperate with a number of threaded rods or fasteners 81 which maintain the previously discussed elements in the stack in ohmic electrical contact and a state of compression. An electrical connection to the stack 70 is established at each of the pair of current collectors 73 and 74 to permit electrical current to flow to a load, not shown. The present design may include a number of heat exchange elements (not shown) which are individually positioned between the respective pairs of adjacent current collectors. This fuel cell stack configuration is more thoroughly described in U.S. Pat. No. 6,703,722, the teachings of which are incorporated by reference herein.

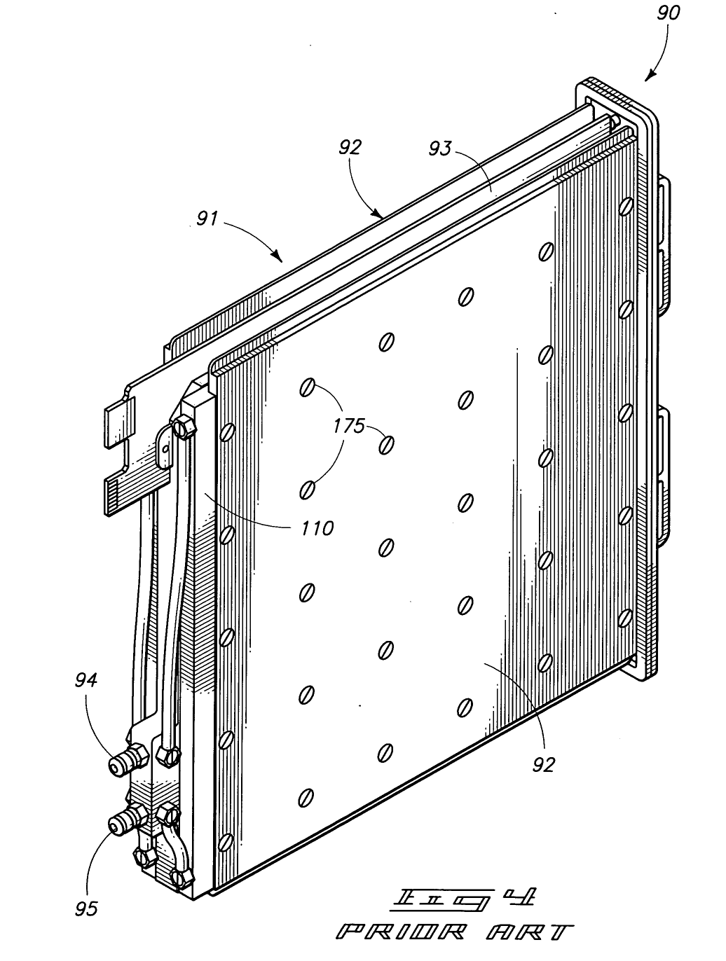

Referring now to FIG. 4, a second fuel cell module is shown, and which is more fully described in U.S. Pat. No. 6,468,682, the teachings of which are incorporated by reference herein. The methodology 10 of the present invention is useful in rendering the present fuel cell module 90, and those representative prior art fuel cell designs as seen in FIGS. 2 and 3, operable to generate electricity once they are supplied with a source of a fuel gas and an oxidant. In this regard, the second fuel cell module 90 has a main body 91 which has opposite anode heat sinks 92 and which are spaced at a predetermined distance apart. The anode heat sinks, in the present fuel cell module are operable to remove a preponderance of the heat energy generated by the fuel cell module during operation. As more fully described in U.S. Pat. No. 6,468,682, the fuel cell module 90 when incorporated within a fuel cell power system, is provided with a bifurcated airflow, a first portion of which passes over the anode heat sinks 92 in order to remove a preponderance of the heat energy generated by the fuel cell module during operation, and a second portion of which passes through the internal portion of the fuel cell module and which provides oxygen, which is necessary for fuel cell module operation. During operation, the fuel cell module 90 generates electrical current which is provided to a current conductor assembly 93 which is positioned atop the fuel cell module 90. The current conductor assembly 93 is operable to direct the electricity generated by the fuel cell module 90 to an electrical bus (not shown) and which is then provided to a load. In addition to the foregoing, the fuel cell module 90 has a fuel delivery passageway 94 which is coupled in fluid flowing relation relative to a source of fuel such as hydrogen and the like. Further, the fuel cell module 90 has an exhaust passageway 95 which removes by-products of fuel cell operation such as water and unused fuel and the like. The second fuel cell module 90 encloses a membrane electrode diffusion layer assembly 11 such as seen in FIG. 1 and which was earlier described.

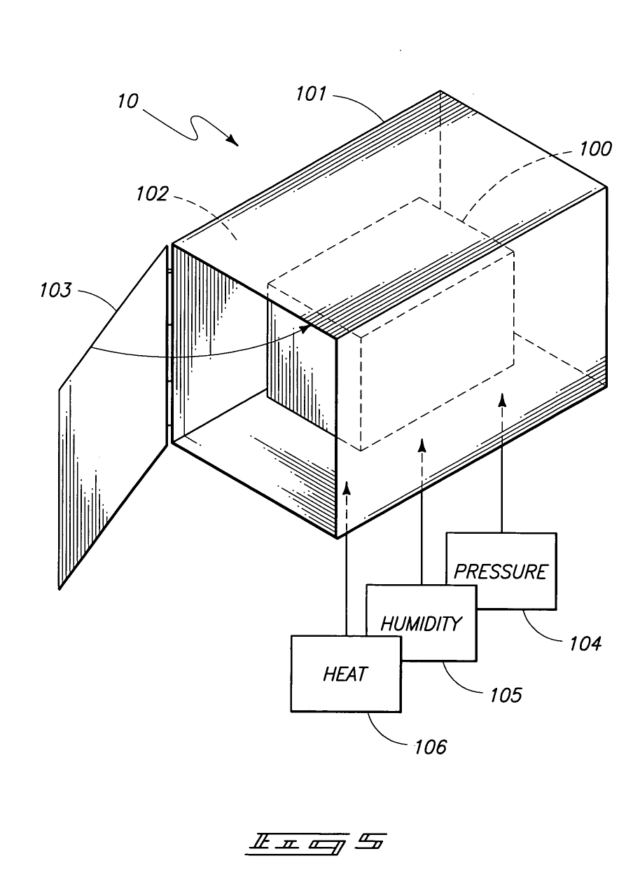

Referring now to FIG. 5, the method for treating a fuel cell membrane 10 of the present invention is seen therein. In its broadest aspect, the method for treating a fuel cell membrane 11 includes, as a first step, providing a fuel cell membrane 11, such as seen in FIG. 1, and incorporating it within a fuel cell component which is generally indicated by the numeral 100. The fuel cell component may be any one of a fuel cell module 60; fuel cell stack 70; or second fuel cell module 90; or other arrangement of fuel cells as described in the prior art. Those skilled in the art will recognize that fuel cell modules 60, and 90 as well as the fuel cell stack 70 constitute non-limiting examples of fuel cell components which will benefit from the teachings of the present invention. It is believed that any fuel cell design which incorporates an ion exchange membrane 12, such as earlier described, would benefit from the present inventive methodology. The fuel cell membrane 11, which may be provided either individually, or in the fuel cell component 100, is not generating an electrical current output. The methodology includes a second step of exposing the fuel cell membrane 11 which is not generating electrical current output to a nonambient environment, here shown as enclosure 101, and which is effective to render the fuel cell membrane substantially immediately operable, after a time period, to generate at least 80% of the maximum sustainable electrical power output of the fuel cell membrane when it is supplied with a source of fuel and an oxidant. An example of such a nonambient environment may be an autoclave. In this regard, the nonambient environment includes an enclosure 101 which defines a cavity 102. A door 103 provides access to the cavity, and allows the cavity to be sealed from the surrounding ambient environment. Still further, the enclosure, and more specifically the cavity thereof, is supplied with a source of pressure 104, humidity 105 and heat 106 such that the fuel cell membrane 11, which may be incorporated into a fuel cell component 100, is exposed to a nonambient environment which has a humidity, pressure and temperature which, as a general matter, is greater than about 10% above the ambient environmental conditions, and during a time period, and at a rate of change which does not significantly damage the nominally operable fuel cell membrane 11. The source of pressure 104, temperature 105 and humidity 106 which is provided within the cavity 102 is effective to hydrate the nominally operable fuel cell membrane 11 in a time period during which the fuel cell membrane is retained within the cavity 102. This temperature, pressure and humidity which is provided to the cavity does not substantially decrease the useful life of the subsequently conditioned fuel cell membrane 11 once it is removed from the cavity, and then rendered operable by a fuel cell component 100 which may include any of the non-limiting fuel cell modules 60 and 90, or fuel cell stack 70 as earlier described.

In the methodology as described, the step of exposing the fuel cell membrane to a nonambient environment includes an additional step of exposing the fuel cell membrane in the nonambient environment to a temperature provided by the source of heat 106 of about 60° C. to a temperature of about 120° C. Still further, the fuel cell membrane in the nonambient environment is exposed to a humidity of about 70% to about 100%. In the methodology described above, the fuel cell membrane 11 is retained in the nonambient environment such as the cavity 102 for a time period of about 30 to about 300 minutes, and at a pressure of greater than about atmospheric pressure to about 150 pounds per square inch. In the methodology as described, and prior to being positioned within the cavity 102 of the enclosure 101 the nominally operable fuel cell membrane 11, which may be incorporated into a fuel cell component 100, and if supplied with a source of fuel and an oxidant prior to being conditioned using the present methodology, would typically produce an electrical power output of less than about 80% of the maximum sustainable electrical power output for same. As will be understood, therefore, the present methodology contemplates that the individual membrane electrode diffusion layer assembly, or ion exchange membrane 12, may be individually received within the cavity 102, or further incorporated into a fuel cell component 100, and wherein the fuel cell module, fuel cell stack, or the like are received, in whole, or in part, within the cavity 102, and are thereby conditioned, as earlier described, by means of the present methodology. In the event that a fuel cell membrane 11 is treated by means of the present methodology, the fuel cell membrane, once removed from the cavity 102, may be subsequently rendered operable within the fuel cell module 60 or 90 or a fuel cell stack 70. The methodology of the present invention provides a convenient means whereby a hand manipulatable fuel cell module such as 60 or 90 or a fuel cell stack, for example, may be produced by means of the present method. In the arrangement as shown, a conditioned fuel cell membrane 11 comprises a nominally operable fuel cell membrane 11 which, prior to conditioning, cannot immediately deliver an optimal electrical power output when supplied with a fuel gas, and an oxidant, and which, following conditioning, and subsequently rendered operational by a fuel cell 100, is operable to supply an optimal electrical power output within less than about 1 hour of operation of the fuel cell. As contemplated by the present methodology, the nominally operable fuel cell membrane 11 may be newly fabricated, or in the alternative, previously utilized, but presently is not appropriately hydrated.

### Operation

The operation of the described embodiment of the present invention is believed to be readily apparent and is briefly summarized at this point.

A method for treating a fuel cell membrane 11, a fuel cell produced by the same method, and a conditioned fuel cell membrane of the present invention is best understood by a study of FIGS. 1-5, respectively. As seen in the drawings, the method 10 for treating a fuel cell membrane 11 of the present invention contemplates the steps of providing a nominally operable fuel cell membrane 11, and which is not currently producing electrical power output; providing an enclosure 101 defining a cavity 102; placing the nominally operable fuel cell membrane in the cavity of the enclosure; increasing the pressure 104, temperature 106, and humidity 105 experienced by the nominally operable fuel cell membrane within the cavity to create a nonambient environment; retaining the nominally operable fuel cell membrane 11 in the cavity for a time period which is effective to render the fuel cell membrane conditioned, and substantially immediately operable to generate at least about 80% of the maximum sustainable electrical power output of the fuel cell membrane when it is subsequently supplied with a source of a fuel gas and an oxidant; and removing the conditioned fuel cell membrane from the enclosure. In the methodology as described, the nominally operable fuel cell membrane, if supplied with a source of fuel, and an oxidant, prior to being conditioned, would produce, on average, an electrical power output of less than about 80% of the maximum sustainable electrical power output for same. In the present methodology 10, the step of increasing the temperature 106, pressure 104, and humidity 105 within the cavity 102 comprises selecting a pressure, temperature and humidity which is provided within the cavity 102, and which is effective to hydrate the nominally operable fuel cell membrane 11 in the time period during which the fuel cell membrane 11 is retained within the cavity. This time period is typically less than about 60 minutes, although in some fuel designs, time periods of up to 300 minutes may be desirable. The temperature, pressure and humidity which is provided during the time period that the nominally operable fuel cell membrane 11 is retained within the cavity 102 takes place during a time period, and at a rate of speed or change during which the temperature, pressure, and humidity are increased, and then maintained in the enclosure 101, and which does not significantly damage the nominally operable fuel cell membrane 11. In the methodology as described, and as contemplated by the present invention, the fuel cell membrane 11 may be incorporated into a fuel cell component 100, and wherein the fuel cell component may be placed within the cavity 102 of the enclosure 101, and exposed to the nonambient environment as provided by same.

Therefore, the methodology of the present invention 10 for treating a fuel cell membrane 11 includes the steps of providing a nominally operable fuel cell membrane 11 which if provided with a source of fuel and an oxidant, would immediately supply an electrical power output of typically less than about 80% of its optimal electrical power output; and selecting a time period for the treatment of the nominally operable fuel cell membrane. In this regard, the methodology includes further steps of providing an enclosure 101 defining a cavity 102; and placing the nominally operable fuel cell membrane within the cavity of the enclosure. This same methodology 10 also includes a further step of selecting and supplying a nonambient and substantially nondamaging temperature, pressure and humidity which is experienced by the nominally operable fuel cell membrane within the cavity 102. The temperature, pressure and humidity which is selected and then provided to the cavity is effective to render the nominally operable fuel cell membrane conditioned, and immediately operable to produce at least about 80% of the conditioned fuel cell membranes' optimal sustainable electrical power output when the conditioned fuel cell membrane is removed from the cavity of the enclosure and is supplied with a source of a fuel and an oxidant. The present methodology also contemplates yet a further step of removing the conditioned fuel cell membrane 11 from the enclosure 101, and rendering the conditioned fuel cell membrane 11 operable to produce an electrical power output which is greater than about 80% of the optimal sustainable electrical power output of the conditioned fuel cell membrane 11. In the present methodology, the temperature as provided by the source of heat 106, and which is experienced by the nominally operable fuel cell membrane within the cavity 102 is greater than about 60° C. Still further, the humidity as provided by the source of humidity 105, and which is experienced by the nominally operable fuel cell membrane within the cavity is greater than about 70 percent. Yet further, the gas pressure as provided by the source of pressure 104, and which is experienced by the nominally operable fuel cell membrane 11 within the cavity is less than about 150 pounds per square inch. The nominally operable fuel cell membrane, once conditioned is then rendered operable within a fuel cell module 60 or 90, or a fuel cell stack 70. As earlier discussed, the fuel cell components 100 may be placed within the cavity 101 in whole, or in part.

Therefore it will be seen that the present invention provides a convenient means whereby manufacturers of various fuel cell designs may render a fuel cell component 100 substantially immediately operable to generate electricity thereby reducing the time period for manufacturing and thus allowing a fully operational product to be delivered to market in a more cost effective manner. Further, the present invention provides a fuel cell which is produced by the present methodology and a conditioned fuel cell membrane.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

We claim:

1. A method for treating a fuel cell membrane, comprising:
providing a fuel cell membrane which is not generating an electrical current output; and
exposing the fuel cell membrane which is not generating an electrical current output to a nonambient environment which is effective to render the fuel cell membrane substantially immediately operable to generate at least about 80% of the maximum sustainable electrical power output of the fuel cell membrane when it is supplied with a source of fuel and an oxidant.

2. A method for treating a fuel cell membrane as claimed in claim 1, and wherein the nonambient environment has a humidity; and a temperature and a pressure, which are greater than about 10% above the ambient environmental conditions.

3. A method as claimed in claim 1, and wherein the step of providing a fuel cell membrane further comprises:
incorporating the fuel cell membrane into a fuel cell component, and wherein the fuel cell component is exposed to the nonambient environment, and wherein the nonambient has a humidity; and a temperature and a pressure, which is greater than about 10% above the ambient environmental conditions.

4. A method as claimed in claim 1, and wherein the step of providing a fuel cell membrane further comprises:
incorporating the fuel cell membrane into a fuel cell module, and wherein the fuel cell module is exposed to the nonambient environment, and wherein the nonambient environment has a humidity; and a pressure and a temperature which is greater than about 10% above the ambient environmental conditions.

5. A method as claimed in claim 1, and wherein the step of providing a fuel cell membrane further comprises:
incorporating the fuel cell membrane into a fuel cell stack, and wherein the fuel cell stack is exposed to the nonambient environment, and wherein the nonambient environment has a humidity; and a pressure and a temperature which is greater than about 10% above the ambient environmental conditions.

6. A method as claimed in claim 2, and wherein the step of exposing the fuel cell membrane to the environment further comprises:
exposing the fuel cell membrane in the nonambient environment to a temperature of less than about 60 degrees C. to about 120 degrees C.

7. A method as claimed in claim 2, and wherein the step of exposing the fuel cell membrane to the nonambient environment further comprises:
exposing the fuel cell membrane in the nonambient environment to a humidity of about 70% to about 100%.

8. A method as claimed in claim 2, and wherein the step of exposing the fuel cell membrane to the nonambient environment further comprises:
retaining the fuel cell membrane in the nonambient environment for a time period of less than about 30 to about 300 minutes.

9. A method as claimed in claim 2, and wherein the step of exposing the fuel cell membrane to the environment further comprises:
exposing the fuel cell membrane in the nonambient environment to a gas pressure of greater than about atmospheric pressure to about 150 pounds per square inch.

10. A method as claimed in claim 2, and wherein the step of exposing the fuel cell membrane to the nonambient environment comprises:
exposing the fuel cell membrane to a temperature of greater than about 60 degrees C.; a humidity of greater than about 70%; and a pressure of less than about 150 pounds per square inch.

11. A method as claimed in claim 1, and wherein the nonambient environment comprises an autoclave.

12. A method of treating a fuel cell membrane, comprising:
providing a nominally operable fuel cell membrane, and which is not currently producing an electrical power output;
providing an enclosure defining a cavity;
placing the nominally operable fuel cell membrane in the cavity of the enclosure;
increasing the pressure, temperature and humidity experienced by the nominally operable fuel cell membrane within the cavity to create a nonambient environment;
retaining the nominally operable fuel cell membrane in the cavity for a time period which is effective to render the fuel cell membrane conditioned and substantially immediately operable to generate at least about 80% of the maximum sustainable electrical power output of the fuel cell membrane when it is subsequently supplied with a source of a fuel gas and an oxidant; and
removing the conditioned fuel cell membrane from the enclosure.

13. A method as claimed in claim 12, and wherein the nominally operable fuel cell membrane, if supplied with a source of fuel, and an oxidant, prior to being conditioned, would produce an electrical power output of less than about 80% of the maximum sustainable electrical power output.

14. A method as claimed in claim 12, and wherein the step of increasing the temperature, pressure and humidity within the cavity further comprises:
maintaining the temperature experienced by the nominally operable fuel cell membrane in the cavity of the enclosure at a temperature of about 60 degrees C. to about 120 degrees C.

15. A method as claimed in claim 12, and wherein the step of increasing the temperature, pressure and humidity within the cavity further comprises:
maintaining the pressure experienced by the nominally operable fuel cell membrane in the cavity at a gas pressure of at least about atmospheric pressure to about 150 pounds per square inch.

16. A method as claimed in claim 12, and wherein the step of increasing the temperature, pressure and humidity within the cavity further comprises:
maintaining the humidity experienced by the nominally operable fuel cell membrane in the cavity at a humidity of about 70% to about 100%.

17. A method as claimed in claim 12, and wherein the step of increasing the temperature, pressure and humidity within the cavity takes place during a time period of less than about 60 minutes.

18. A method as claimed in claim 12, and wherein the step of increasing the temperature, pressure and humidity within the cavity takes place during a time period, and at a rate which does not significantly damage the nominally operable fuel cell membrane.

19. A method as claimed in claim 12, and wherein before the step of increasing the temperature, pressure and humidity within the cavity, the method further comprises:
selecting a pressure, temperature and humidity which is provided within the cavity, and which is effective to hydrate the nominally operable fuel cell membrane in the time period in which the fuel cell membrane is retained within the cavity.

20. A method as claimed in claim 19, and wherein the pressure, temperature and humidity which is provided within the cavity is greater than the surrounding ambient environmental pressure, temperature and humidity as measured at a location which is outside of the cavity; and less than a pressure, temperature and humidity as provided within the cavity, and which would significantly impair the operability of the conditioned fuel cell membrane when the conditioned fuel cell membrane is subsequently removed from the enclosure and rendered operational to generate electricity.

21. A conditioned fuel cell membrane produced by the method of claim 12.

22. A method as claimed in claim 12, and wherein the nominally operable fuel cell membrane is incorporated within a hand manipulatable fuel cell module, and wherein the fuel cell module is placed within the cavity, and wherein the fuel cell module is not supplied with a source of fuel gas while the fuel cell module is within the cavity.

23. A method as claimed in claim 12, and wherein the nominally operable fuel cell membrane is incorporated into a fuel cell stack, and wherein the fuel cell stack is placed within the cavity, and wherein the fuel cell stack is not supplied with a source of a fuel gas while the fuel cell stack is within the cavity.

24. A method as claimed in claim 12, and wherein the fuel cell membrane is incorporated into a fuel cell, and wherein the fuel cell is placed, at least in part, within the cavity.

25. A fuel cell module produced by the method of claim 22.

26. A fuel cell stack produced by the method of claim 23

27. A fuel cell produced by the method of claim 24.

28. A method of treating a fuel cell membrane, comprising:
providing a nominally operable fuel cell membrane which, if provided with a source of fuel and an oxidant, would immediately supply an electrical power output of less than about 80% of its optimal electrical power output;
selecting a time period for the treatment of the nominally operable fuel cell membrane;
providing an enclosure defining a cavity;
placing the nominally operable fuel cell membrane within the cavity of the enclosure;
selecting and supplying a nonambient and substantially nondamaging temperature, pressure and humidity which is experienced by the nominally operable fuel cell membrane within the cavity, and which is effective to render the nominally operable fuel cell membrane conditioned, and immediately operable to produce at least about 80% of the conditioned fuel cell membranes' optimal sustainable electrical power output when the conditioned fuel cell membrane is removed from the cavity of the enclosure and is supplied with a source of a fuel and an oxidant;
removing the conditioned fuel cell membrane from the enclosure; and
rendering the conditioned fuel cell membrane operable to produce an electrical power output which is greater than about 80% of the optimal sustainable electrical power output of the conditioned fuel cell membrane.

29. A method as claimed in claim 28, and wherein the step of selecting and supplying a temperature, pressure and humidity within the cavity further comprises:
maintaining the temperature, pressure and humidity of the cavity in a range, and during the selected time period, which does not substantially decrease the useful life of the conditioned fuel cell membrane once it is removed from the cavity, and then rendered operable by a fuel cell.

30. A method as claimed in claim 29, and wherein the gas pressure experienced by the nominally operable fuel cell membrane within the cavity is less than about 150 pounds per square inch.

31. A method as claimed in claim 29, and wherein the temperature experienced by the nominally operable fuel cell membrane within the cavity is greater than about 60 degrees C.

32. A method as claimed in claim 29, and wherein the humidity experienced by the nominally operable fuel cell membrane within the cavity is greater than about 70 percent.

33. A method as claimed in claim 29, and wherein the gas pressure experienced by the nominally operable fuel cell membrane within the cavity is less than about 150 pounds per square inch; the ambient temperature experienced by the nominally operable fuel cell membrane within the cavity is less than about 120 degrees C.; and the ambient humidity experienced by the nominally operable fuel cell membrane within the cavity is less than about 100 percent.

34. A method as claimed in claim 29, and wherein the fuel cell membrane is subsequently rendered operable within a fuel cell module.

35. A method as claimed in claim 29, and wherein the fuel cell membrane is subsequently rendered operable within a fuel cell stack.

36. A method as claimed in claim 29, and wherein the fuel cell is placed, at least in part, within the cavity.

37. A method as claimed in claim 34, and wherein the fuel cell module is a hand manipulatable fuel cell module, and wherein the hand manipulatable fuel cell module is placed within the cavity.

38. A method as claimed in claim 35, and wherein the fuel cell stack is received, at least in part, within the cavity.

39. A fuel cell stack produced by the method of claim 38.

40. A hand manipulatable fuel cell module produced by the method of claim 32.

41. A conditioned fuel cell membrane comprising:
a nominally operable fuel cell membrane which, prior to conditioning, cannot immediately deliver an optimal electrical power output when supplied with a fuel gas and an oxidant, and which, following conditioning, and when subsequently rendered operational by a fuel cell, is operable to supply an optimal electrical power output within less than about one hour of operation of the fuel cell.

42. A conditioned fuel cell membrane as claimed in claim 41, and wherein the nominally operable fuel cell membrane is newly fabricated.

43. A conditioned fuel cell membrane as claimed in claim 41, and which has an electrical power output of at least about 80% of the maximum sustainable electrical power output for the conditioned fuel cell membrane at less than about one hour after operation of the fuel cell.

44. A conditioned fuel cell membrane as claimed in claim 41, and which is rendered operable by a hand manipulatable fuel cell module.

45. A conditioned fuel cell membrane as claimed in claim 41, and which is rendered operable by a fuel cell stack.

46. A fuel cell membrane as claimed in claim 45, and wherein a gas diffusion layer is affixed to the nominally operable fuel cell membrane.
